(19) United States
(12) Patent Application Publication
(10) Pub. No.: US 2024/0081460 A1
(43) Pub. Date: Mar. 14, 2024

(54) HELMET PADS WITH DIRECT-WELDED SUPPORT STRUCTURES

(71) Applicants: David Stoutamire, Menlo Park, CA (US); Whitman Kwok, Emerald Hills, CA (US); Louis Novy, Menlo Park, CA (US)

(72) Inventors: David Stoutamire, Menlo Park, CA (US); Whitman Kwok, Emerald Hills, CA (US); Louis Novy, Menlo Park, CA (US)

(21) Appl. No.: 18/512,742

(22) Filed: Nov. 17, 2023

Related U.S. Application Data
(63) Continuation-in-part of application No. 17/957,766, filed on Sep. 30, 2022.
(60) Provisional application No. 63/324,972, filed on Mar. 29, 2022.
(60) Provisional application No. 63/251,164, filed on Oct. 1, 2021.
(60) Provisional application No. 63/426,233, filed on Nov. 17, 2022.

(51) Int. Cl. A42B 3/12; B29C 64/118

(52) U.S. Cl. CPC A42B 3/12; B29C 64/118

(57) ABSTRACT

A pad assembly for a helmet comprises a pad formed of a first material and a support structure of a second material that is formed on and bonded to the pad by means of an additive manufacturing process. The first material and the second material being selected to bond together when the support structure is formed on the pad during the additive manufacturing process. In one example the pad assembly comprises a crescent-shaped conformal strip with a flange that is received in a corresponding groove in the helmet. In another example, the pad assembly comprises a plate having posts formed thereon for engaging corresponding holes formed in the helmet. Also disclosed is a helmet including a pad assembly.

### PRIORITY APPLICATIONS

This application is continuation-in-part application of U.S. patent application Ser. No. 17/957,766, filed Sep. 30, 2022, which application claims the benefit of priority to both U.S. Provisional Patent Application Ser. No. 63/324,972, filed Mar. 29, 2022 and U.S. Provisional Patent Application Ser. No. 63/251,164, filed Oct. 1, 2021, the contents of which are incorporated herein by reference as if explicitly set forth.

The current application also claims the benefit of priority to U.S. Provisional Patent Application Ser. No. 63/426,233 filed on Nov. 17, 2022, the content of which is incorporated herein by reference in its entirety.

### FIELD OF THE INVENTION

This application relates to structures and methods for use in protective equipment, including but not limited to helmets for use in recreational activities.

### BACKGROUND

Designers of protective equipment are often faced with many conflicting requirements and challenges. For example, helmets for sporting use are expected to be lightweight, able to withstand and absorb significant impacts of different types and directions, capable of providing air flow to the wearer's head in use, as well as a comfortable and conformable fit that can accommodate variations in the size or shape of a user's head within each specific helmet size. Additionally, sweat management in helmets used for activities such as cycling, can be a challenge. Considerations of style, and the limitations of existing molding techniques in Expanded Polystyrene (EPS) molding, are also relevant.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is an exploded view of a constant-force pad assembly to be used in protective equipment, such as helmets, according to some examples.

FIG. 2 shows a perspective view of a helmet substrate, according to some examples.

FIG. 3 shows a perspective views of the helmet substrate of FIG. 2.

FIG. 4 is a perspective view of a pad assembly in which springs used to provide the constant force deflection reside in the helmet substrate, according to some examples.

FIG. 5 shows a perspective view of a helmet substrate in which hidden detail of post holes is shown, according to some examples.

FIG. 6 shows two polymer constant-force accordion-shaped springs designed for FDM fabrication, according to some examples.

FIG. 7 is a perspective view of a jig for use in manufacturing of a pad assembly according to some examples.

FIG. 8 is a flowchart illustrating the manufacture of a pad assembly according to some examples.

FIG. 9 is a top view of a pad assembly forming a conformal band for use in a helmet according to some examples.

FIG. 10 is a perspective partial view of the inside front of a helmet for use with the conformal band of FIG. 9.

FIG. 11 is a perspective partial cross-sectional view of the conformal band of FIG. 9, according to some examples.

FIG. 12 is a perspective partial cross-sectional view of the conformal band of FIG. 9 located in the helmet of FIG. 10.

FIG. 13 shows a conformal band according to some examples.

FIG. 14 is a perspective view of the conformal band of FIG. 13 according to some examples.

FIG. 15 shows a pad assembly comprising a conformal band according to some further examples.

FIG. 16 is a closeup of a section of the conformal band of FIG. 15.

FIG. 17 is perspective view of the interior of a helmet according to some examples.

### DETAILED DESCRIPTION

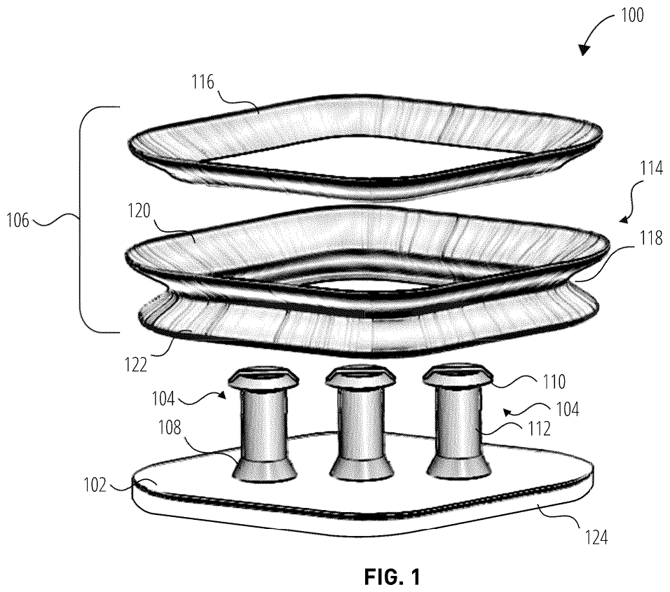

FIG. 1 is an exploded view of a constant-force pad assembly 100 to be used in protective equipment, such as helmets, according to some examples. Pads are used in many applications to isolate a rigid surface from a human body part. For example, foam pads are commonly incorporated into sports gear, such as helmets, to provide user comfort. Pads fill the gap between the substrate and the body to allow equipment to be worn despite having an imprecise fit. Pads are commonly made of a foam. There may be additional layers to control the force-displacement curve, wick sweat, adhere to the substrate, provide an attractive appearance, and so on.

Pads are most comfortable when they provide a consistent and controlled pressure. When sports equipment has a poor fit, the pressure may be too small (or zero) such that the equipment is not held in place correctly. Alternately, pressure that is too high is uncomfortable or painful. Foam pads generally transmit more force as they get squeezed into a smaller volume. However, this limits the comfortable range of motion. While a conventional pad allows choosing a density to increase or decrease pressure, this cannot guarantee comfort as the ideal density will still differ with fit, and pressure may not be evenly distributed across the pad.

One possible approach is to use a viscoelastic material (“memory foam”) so that pressure points even out over time. A potential problem with memory foam is its reduced ability to sustain constant pressure over time.

Instead of a foam, pressure may be spread using a relatively stiffer panel that distributes load over the entire pad surface. The stiffness may be chosen to allow some curvature (e.g., across the forehead), while still distributing force at small scales. Deflection of the pad is arranged to provide a somewhat flat force-displacement curve.

The pad assembly 100 shown in FIG. 1 comprises a relatively stiff and smooth plate 102 with rounded edges suitable for prolonged contact with skin, which distributes load evenly to prevent pressure points, posts 104 for coupling the pad assembly 100 to the helmet, and a spring 106 that provides a relatively constant force-displacement curve.

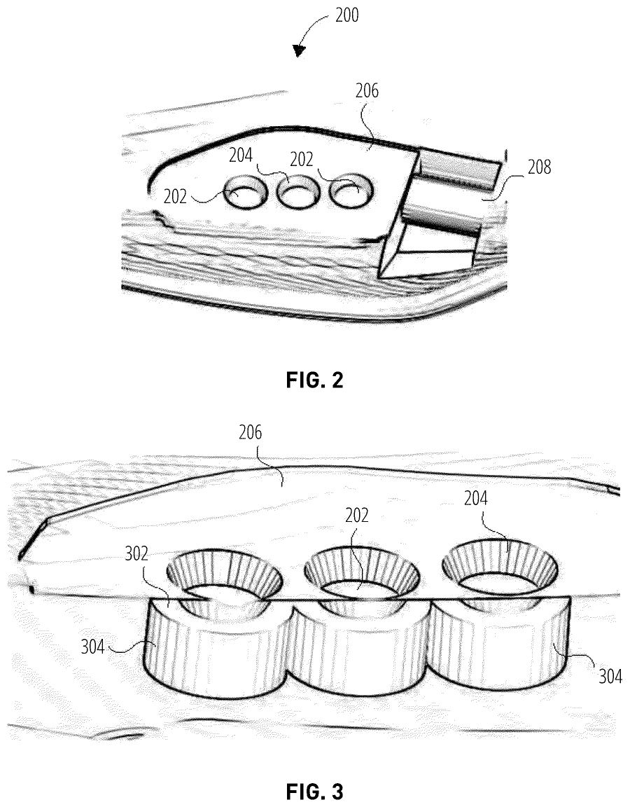

Each post 104 includes a conical base 108 for stability, which mates with a conical upper edge 204 of a post holes 202 in the helmet substrate as shown in FIG. 2 and FIG. 3, a body 112 that slides into the post holes 202 in the substrate to permit the pad to deflect and retract toward the substrate under pressure, and a conical split snap feature 110 that permits insertion into but not retraction of each post 104, to hold the pad assembly 100 in place on the helmet substrate. The end of the post 104 is thus able to snap into place in a post hole while the undersurface of the conical split snap feature 110 prevents withdrawal by engaging a corresponding surface in the post hole.

The spring 106 comprises primary walls 114 that are aligned with the boundary of the pad assembly 100 to permit movement of the plate 102 relative to the helmet substrate, as well as a secondary wall 116 that prevents inversion of the primary walls 114 where the primary walls 114 meet the substrate. In one example the components of the pad can be 3D printed simultaneously and bonded thermally by proximity.

To obtain a force-displacement curve that is flat instead of stiffening with displacement, the primary walls 114 comprise an angled first wall 120 and an angled second wall 122 that meet at a waist 118, where buckling occurs when pressure is applied to the pad assembly 100. In contrast to a traditional pad, the material properties only affect stiffness at the point (the waist 118) where buckling occurs. The buckling mechanism described in this example is an inward bend in the pad primary walls 114, but other arrangements are possible.

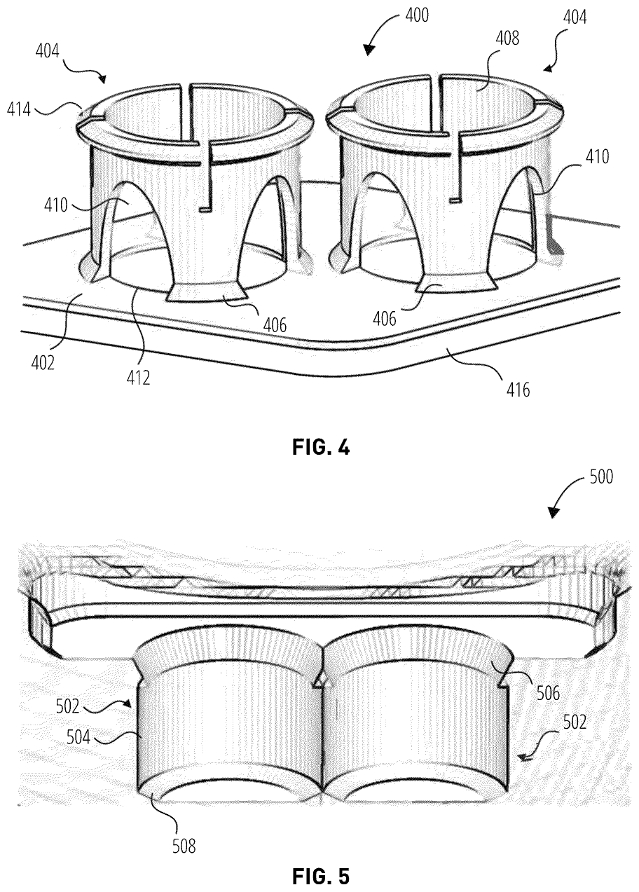

The material used for construction of the pad assembly 100 can be quite stiff relative to traditional foam. To provide comfortable contact with the wearer foam, wicking fabric or aesthetic material is laser, knife or die-cut and adhered to the surface of the plate 102 opposite to the posts 104 to form a pad 124 for contact with the wearer's head. In some examples, the pad 124 and the plate 102 are manufactured and adhered together as discussed below with reference to pad 416 illustrated in FIG. 4. A preferred material for the pad assembly 100 (excluding the pad 124) is olefin block copolymer (OBC), with polyether thermoplastic polyurethane (TPU) of shore 95 A durometer also being suitable. The plate 102 and the posts 104 thus form a support structure by means of which the pad 124 is positioned, held in place, and supported in a helmet substrate 200.

Because the spring 106 has a flatter force-displacement curve than foam, the range of displacement can be larger than a traditional pad, without discomfort. The recess for the pad assembly 100 in the substrate and the depth of the holes for receiving the mounting posts can also be designed to accommodate the entire retracted pad assembly 100 all the way to the adjacent surface of the substrate.

The secondary wall 116 prevents the primary walls 114 from turning inside-out (inversion) when the pad assembly 100 is deeply depressed. Another solution would be to thicken the perimeter of the first wall 120 in the area that comes in contact with the recess in the substrate. Such thickening prevents undue expansion of the first wall 120 without affecting the apparent stiffness, because the compliance of the primary walls 114 is primarily at the waist 118.

As used herein, the term “assembly” refers to a component that has parts or regions that perform different functions, whether formed as a single item or multiple items that are joined together to form the “assembly.”

FIG. 2 shows a perspective view of a helmet substrate 200 according to some examples. The substrate 200 forms part of a helmet shell for example. The substrate 200 includes three post holes 202 sized and located to receive the posts 104 of the pad assembly 100. The post holes 202 are deep enough to allow each post 104 to fully extend into its post hole 202 when the pad assembly 100 is under pressure. Post hole upper edges 204 are conical to facilitate post insertion and also for engagement with the conical post bases 108 when the pad is fully depressed, to provide additional lateral support to the pad assembly 100 when fully depressed. The undersides of the split snap features 110 engage corresponding surfaces in the post holes 202 to prevent withdrawal of the posts 104 from the post holes 202.

Also defined in the substrate is a recess 206 that matches the overall shape of the pad assembly 100. In some cases, the floor of the recess 206 does not correspond to the entire shape of the pad assembly 100 as shown, which permits the pad assembly 100 to overlap with other functional equipment areas, such as the strap support 208 seen in the figure.

FIG. 3 shows a perspective view of the helmet substrate 200 of FIG. 2, in which hidden detail of the post holes 202 is shown. A lower region 304 of each post hole 202 is sufficiently wide so as to fully accommodate the split snap feature 110. An upper surface 302 of the lower region engages the undersurface of the conical split snap feature 110 to prevent post withdrawal, while allowing each post 104 to slide in to its full depth.

The apparatus shown in FIG. 1, FIG. 2 and FIG. 3 combines the pad surface, constant force spring, and the conical retention snaps into a single part. These functions may instead be separated to allow independent fabrication, different materials, alternative assembly methods, end user adjustments, or greater depth of travel. FIG. 4 to FIG. 6 together illustrate an alternate constant force pad implementation in which springs are separate parts that reside in the helmet substrate for increased range of motion.

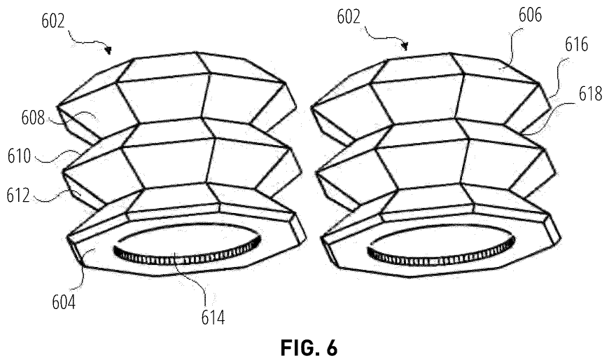

FIG. 4 is a perspective view of a pad assembly 400 in which the springs used to provide the constant force deflection reside in the helmet substrate, according to some examples. The pad assembly 400 combines the functions of the plate 102 and posts 104 of the pad assembly 100 of FIG. 1, excluding the spring 106. As before, the pad assembly 400 includes a relatively stiff and smooth plate 402 with rounded edges suitable for prolonged contact with skin, and for distributing load evenly to prevent pressure points. The pad assembly 400 includes posts 404 with partial conical bases 406 for stability, which mate with a conical upper edge 506 of post holes 502 (see FIG. 5) in the helmet substrate. In some examples, the posts 404 shown in FIG. 4 slide into post holes 502 in the helmet substrate against springs 602 (see FIG. 6) in the post holes 502, to permit the pad assembly 400 to retract toward the substrate under pressure. The posts 404 in FIG. 4 can however also be used with an outer spring arrangement attached to the pad assembly 400 as describe above with reference to FIG. 1.

The posts 404 include four-way conical split snap features 408 that permit insertion of a post 404 into, but not retraction of, a post 404 from a post hole 502, to hold the pad assembly 400 in place. Arches 410 are defined in the post walls and holes 412 are provided in the plate 402, for example under the posts 404, to reduce overall weight. An upper surface 414 of the split snap feature 408 may have an angled outer portion to permit insertion of the posts 404 into the post holes 502, and a flat upper portion to engage a spring 602. The pad assembly 400 also includes a foam pad 416. Traditionally, bonding the plate 402 and the pad 416 would require an adhesive application step. This can be avoided by using an additive manufacturing process such as Fused Deposition Modeling (FDM) to bond the plate 402 and the pad 416 directly to each other.

The plate 402 and the posts 404 thus form a support structure by means of which the pad 416 is positioned, held in place, and supported in a helmet substrate 500.

In some examples, the pad 416 also includes a sheathing, such as a wicking fabric, which is often bonded or laminated by the manufacturer of the material from which the pad 416 is made. The substrate(s) and any FDM-printed materials need to be chemically compatible for effective bonding or welding; chemically similar thermoplastics such as two polyethylene blends or two polyether polyurethanes are used in some examples. A series of two or more different materials may be welded by FDM if all materials overlap Hansen solubility parameters.

FIG. 5 shows a perspective view of a helmet substrate 500 in which hidden detail of post holes 502 is shown, according to some examples. FIG. 5 shows the post holes 502 as if seen from within the helmet substrate. The post holes 502 in FIG. 5 are functionally equivalent to the post holes 202 in FIG. 2, and are appropriately sized (for example with a larger diameter and deeper depth) to accommodate a spring 602 in each post hole 502. Each post hole 502 includes a chamfer 508 at the bottom that encourages a spring 602 to remain centrally aligned.

The post holes 502 are deep enough to allow each post 404 to fully extend into its post hole 502 on top of a compressed spring 602 when the pad assembly 400 is under pressure. Post hole upper edges 506 are conical to facilitate post insertion of a the posts 404 and also for engagement with the post conical bases 406 when the pad assembly 400 is fully depressed, to provide additional lateral support to the pad assembly 400 when fully depressed. The undersides of the split snap features 408 engage corresponding surfaces in the post holes 502 to prevent withdrawal of the posts 404 from the post holes 502.

A lower region 504 of each post hole 502 is sufficiently wide so as to fully accommodate the split snap feature 408 and a spring 602, which may expand radially when compressed.

Any type of spring may be used within the post holes 502, but preferably constant force springs are used.

FIG. 6 shows two polymer constant-force accordion-shaped springs 602 designed for FDM fabrication. Each spring 602 has a flat end 604 that is contacted by the end of the post 404 and a tapered end 606 for contacting the chamfer 508 at the bottom of the post hole 502. The springs 602 are hollow to permit the alternating spring walls (such as spring wall 608 and spring wall 610) to compress and expand towards and away from each other during use. The flat end 604 of each spring 602 also includes a hole 614 to reduce weight and to allow users to manipulate the springs 602 during insertion or replacement.

The spring force provided by the springs 602 is primarily as a result of buckling occurring at the outer edges 616 and waists 618 between adjacent spring walls, such as spring wall 608, 610 and 612. The springs 602 may be any shape, but the octagonal radial accordion design illustrated in FIG. 6 reduces engagement with any imperfections in or on the walls of the lower region 504 of the post hole 502.

The spring 106 in FIG. 1 and the springs 602 in FIG. 6 may be seen as a stack of effectively conical shells (also known as coned-disc springs, conical spring washers, or Belleville springs.) These compact springs feature a force plateau near zero at the point where the spring “turns inside out,” so the force-displacement profile can be tuned by modifying the dimensions of the spring for the desired displacement.

Any mechanism capable of plateauing force may be substituted, including but not limited to: cantilever springs, volute springs, leaf springs, torsion springs, wave springs, gas springs, main springs, or dilatant or auxetic foams and lattices.

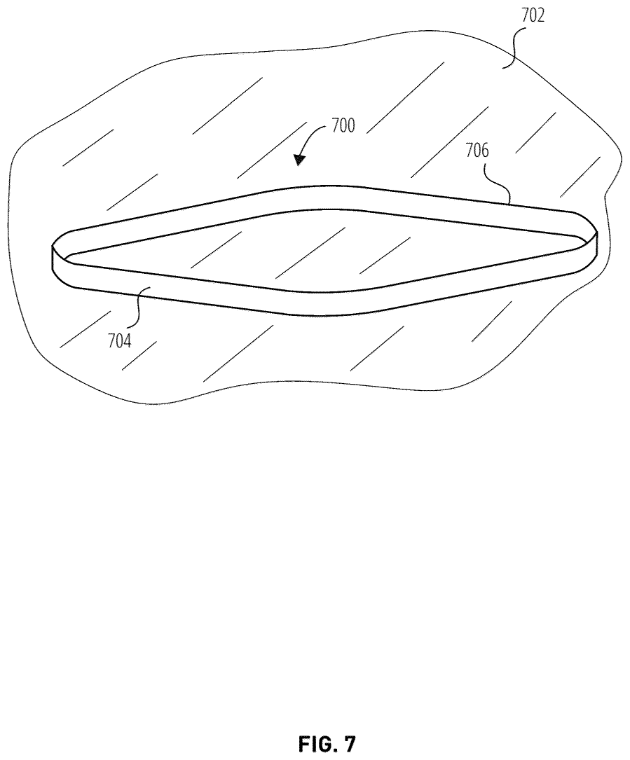

FIG. 7 is a jig 700 for use in manufacturing of a pad assembly 400 according to some examples. The jig has a wall 704 that is formed in the shape of the pad assembly 400 and includes an inwardly protruding lip 706 for retaining the upper edge of the pad 416 during printing of the plate 402 and the other components thereon. In some examples, the jig 700 is printed on a print bed 702 or other substrate of an additive manufacturing printer, or alternatively the jig 700 includes features for attaching the jig 700 securely to the print bed 702. As used herein, “print bed” includes the use of intermediate substrates. By printing the jig 700 in the same set of print operations as the pad assembly 400, the positional relationship between the print head and the jig 700 does not need to be established before the pad assembly 400 can be printed.

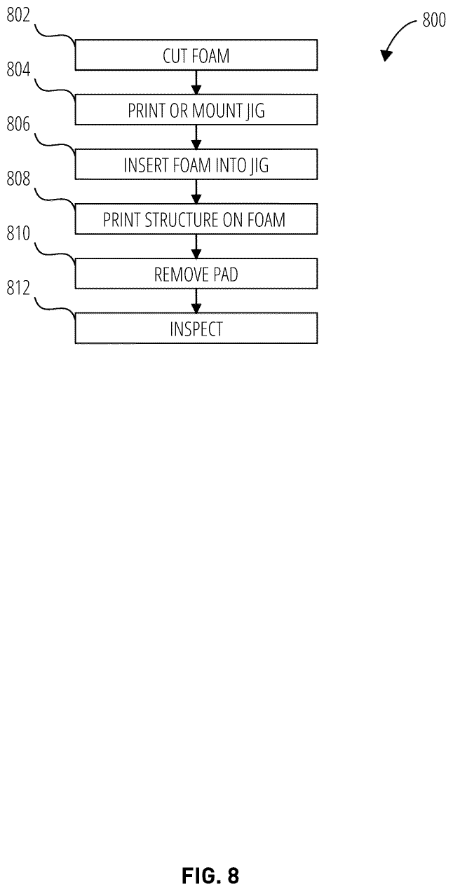

FIG. 8 is a flowchart 800 illustrating the manufacture of a pad assembly 400 (or pad assembly 100) according to some examples. This process is also used to manufacture the conformal band 900 described below.

In one example, Ethylene Vinyl Acetate (EVA) foam is used for the pad 416. Various materials are suitable for the plate 402. For example, all classes of thermoplastic polyurethane TPU can work. For the purposes of FDM additive manufacturing, TPUs in the durometer range of 90 A to 75 D are suitable. In some examples, a TPU with a durometer of 95 A is used for the support structure 904 of the conformal band 900. In some examples, OBC is used due to its lighter weight and higher stiffness/weight ratio. Thermoplastic elastomers (TPR) and polyether block amide can also be used in some examples.

In operation 802 a piece of foam is cut from a sheet of foam, in the intended shape of the pad 416, 902. A jig (such as jig 700) is formed on the printer bed in the intended shape of the pad 416, 902 in operation 804, using Fused Deposition Modeling (FDM).

The pad 416, 902 is then placed into the complementary-shaped recess in the jig in operation 806. Correct and secure placement of the pad 124, 902 is ensured by pressing down on the pad 416, 902 in the corners of the jig and tucking it under the lip formed along the upper edges of the jig. The lip (such as lip 706) helps to contain the pad and reduces warping or curling during the printing of the support structure on the pad.

The pad 416, 902 is then printed on directly in operation 808 to form the applicable support structure (plate 402 and posts 404 or support structure 904). In some examples this is performed using a Fused Deposition Modeling (FDM) printer at a set temperature of 180-285 deg C., preferably 230-285 C, with a print speed of 15-90 mm/s to form the plate 402 and posts 404. By choosing a foam and FDM filament that are chemically compatible (EVA and OBC or a polyolefin), the heat of the extruder will fuse the plate 402 to the pad 416. This results in a strong and robust bond without a separate manufacturing step, separate bonding agents (epoxy, resin or adhesives), or use of additional supporting structures. In some examples the layer height to nozzle ratio is 0.5 (e.g. 0.2 mm layer height for a 0.4 mm nozzle), however lower or higher layer/nozzle ratios may suffice depending on preferred speed, bonding requirements and material variations. In some examples a 0.1-0.3 mm line height is used.

For a heavier but more flexible larger pad, Thermoplastic Polyurethane (TPU) between 55 A-100 A Shore Durometer (though harder TPUs are also suitable) is printed on a common 1-5 mm laminated polyurethane (PU) fabric using a 0.4 mm nozzle and 0.2 mm layer height at 180-260 C with a print speed of <70 mm/s in some examples. Printing can be done using a nozzle from 0.3 to 1.0 mm or greater and a layer height of >0.1 mm up to roughly half the size of the nozzle. Smaller nozzles or layer heights can cause clogging or print failures. OBC or TPE is also suitable—the intent is to use a relatively flexible material, for which the durometer is a reasonable proxy.

The pad assembly 400 or conformal band 900 is then removed from the jig in operation 810 and inspected for manufacturing defects in operation 812.

Such direct welding can be used not only for pads but any other structures that need to combine dissimilar materials, for example, straps, buckles, pins, artwork, helmet sub-components, separately printed 3d parts, and so forth.

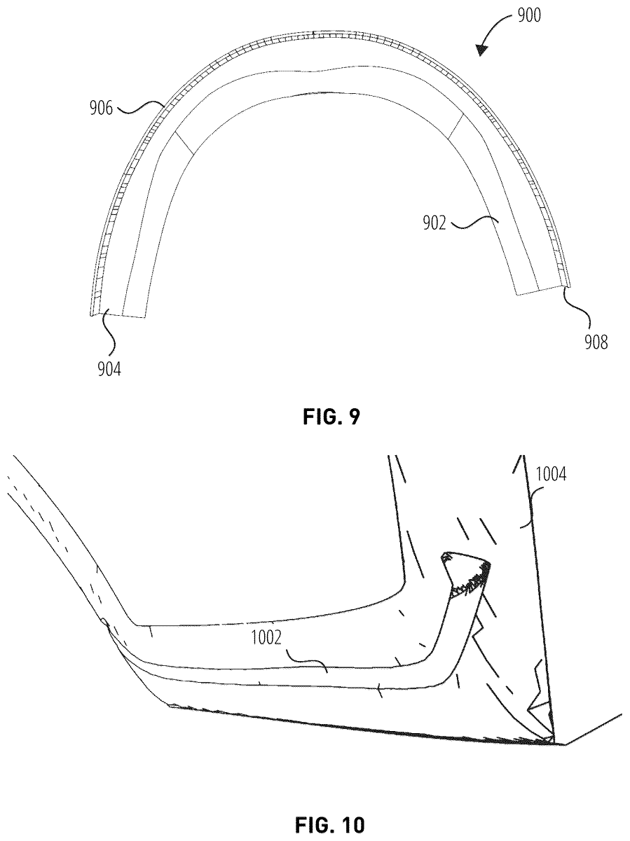

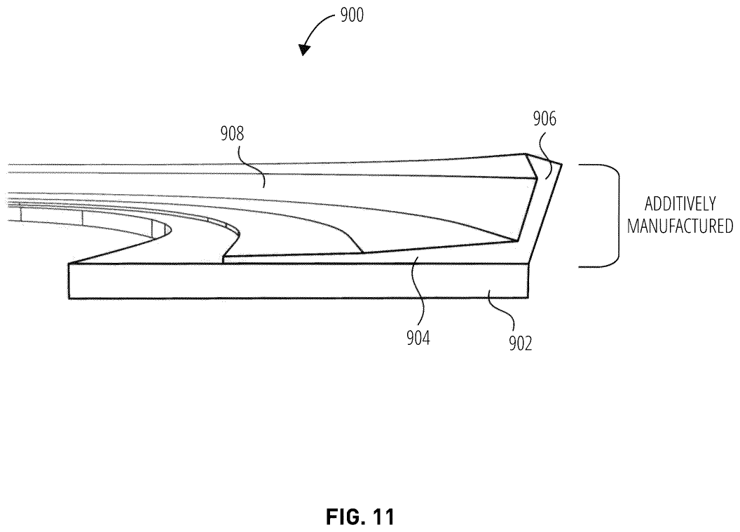

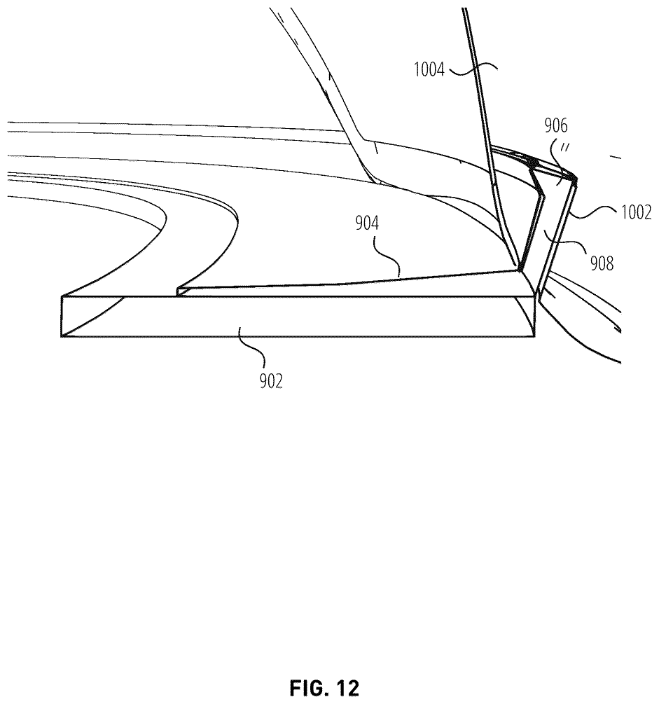

FIG. 9 is a top view of a pad assembly in the form of a conformal band 900 for use in a helmet according to some examples. The conformal band 900 comprises a pad 902 attached to a support structure 904 that includes a flange 908 and an interlocking feature 906. See further FIG. 11. In some examples the pad 902 is a strip of foam cut from a sheet of foam. The flange 908 and the interlocking feature 906 of the support structure 904 fit into a groove formed inside the front of a helmet 1004. The conformal band 900 contacts a user's forehead to provide sweat wicking, a sweat barrier and enhanced fit and comfort by distributing contact loads over a greater surface are, extending the working range of comfortable fit. In addition to wicking and guiding sweat away from face, in some examples the conformal band 900 also directs airflow, and offers better weight ratios than other types of pads.

FIG. 10 is a perspective partial view of the inside front of a helmet 1004 for use with the conformal band 900 of FIG. 9, according to some examples. As can be seen, a groove 1002 is formed along the inside of the front of the helmet 1004, which may have been customized to the wearer's personal head shape. The groove 1002 may be produced as a monolithic portion of the main helmet body and be of any material, or as a separate part that is assembled with other parts to form the helmet 1004. The groove 1002 has a cross-sectional shape that permits mating of the flange 908 and interlocking feature 906 of the conformal band 900 with the helmet 1004, while allowing assembly either by pushing or sliding the conformal band 900 from an end of the groove 1002. In some examples the helmet or part thereof is formed by a polycarbonate copolymer, with the groove 1002 described above, formed by FDM.

The conformal band 900 is formed using the direct bonding or welding technique described above with reference to the pad assembly 100. In particular, the pad 902 and support structure 904 are formed in the same way that the pad 416 and the plate 402 are formed and bonded. The pad 902 in some examples is formed of ethylene-vinyl acetate (EVA) with fabric laminated on both sides, and is formed by laser cutting, and the elastic polyurethane support structure 904 is welded or bonded directly to the pad 902 by FDM printing as described above with reference to FIG. 9. FDM printing can be done on both the pad 902 itself or on a synthetic fabric covering such as polyester. It may be difficult to print through the fabric to the underlying foam, and so the fabric is selected to be thin enough or of a type that allows sufficient FDM material through to the pad 902 itself to ensure a reliable bond.

The materials for the conformal band 900 are chosen for elasticity, comfort against the skin, wicking of sweat, and attractiveness. The elasticity of the conformal band 900 is controlled by the shape of FDM printing forming the support structure 904 on top of the pad 902, to optimize the properties of the fabric/foam for comfort and effectiveness.

Forming the conformal band 900 using FDM to bond the pad 902 and the support structure 904 provides a single item that can be installed easily and/or installed or replaced by the customer, and multiple conformal bands 900 may be provided with a single helmet for selection and customization by the user. It is possible for the combined conformal band 900 to be made to conform to the unique shape of the head that the helmet is being customized for by changing the width of the structure, changing the thickness of the structure, or by printing anisotropic patterns. Customer directed artwork or labelling can also be incorporated using the laser if the pad 902 is laser cut, or in the FDM printing itself.

FIG. 11 is a perspective partial cross-sectional view of the conformal band 900 of FIG. 9, and FIG. 12 is a perspective partial cross-sectional view of the conformal band 900 of FIG. 9 located in the helmet 1004 of FIG. 10, according to some examples. As can be seen, the conformal band 900 comprises a pad 902 having a support structure 904 formed thereon. Also shown is the flange 908 and an interlocking feature 906 that engages with the groove 1002 in the helmet 1004. An angle between the flange 908 and the pad 902 is selected, in conjunction with the position and orientation of the groove 1002 in the helmet 1004 so that the foam strip is angled slightly upward relative to the location of a user's forehead when positioned in the helmet 1004. In this example, the angle between the flange 908 and the pad 902 is an obtuse angle, to facilitate an acute angle between the foam strip and the user's forehead. This angle between the user's forehead and the pad 902 facilitates putting the helmet on and helps ensure a downward angle from the user's forehead to the front of the helmet, which can help with collection and wicking of sweat away from the user's forehead to the front of the helmet.

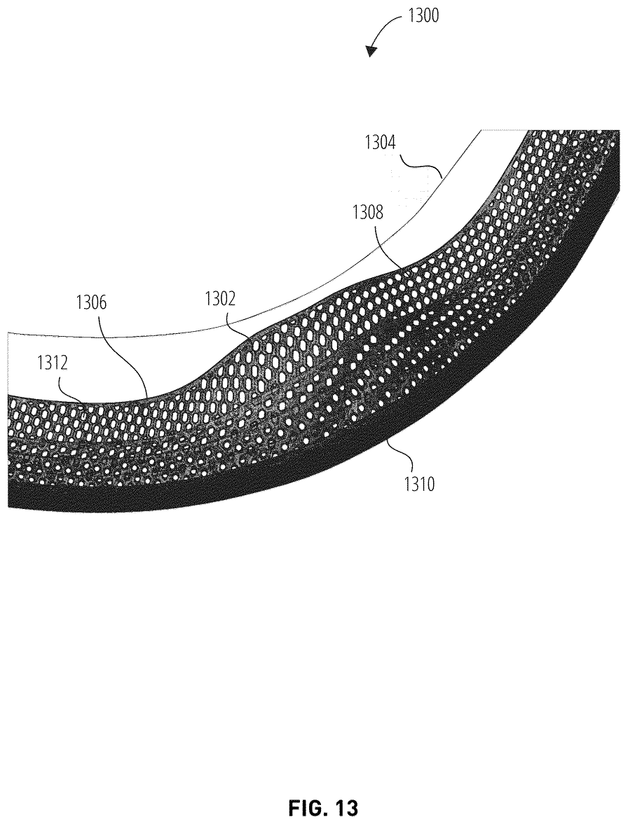

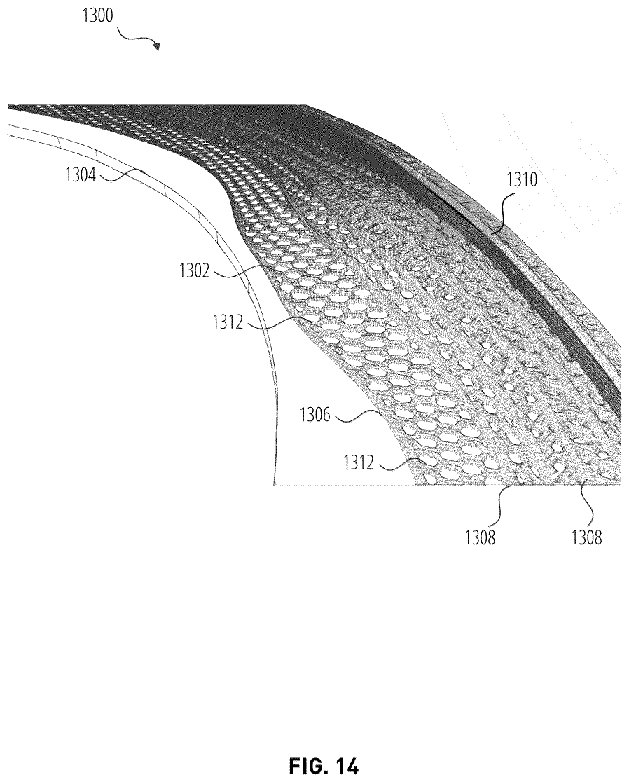

FIG. 13 and FIG. 14 show a conformal band 1300 according to some examples. As can be seen, the conformal band 1300 includes a support structure 1302 having a variable inner profile 1306 compared to the profile of a foam strip 1304, as well as having holes 1312 defined therein. More generally, patterns (holes, diamonds, squares or a generative pattern optimized for the desired conformal behavior) can be provided. The support structure 1302 also includes circumferential ribs 1308 that decrease in height from the flange 1310 to the inner profile 1306. These three features can be adjusted to obtain desired force and displacement characteristics for the conformal band 1300, and can also be varied around the conformal band 1300 to provide different force and displacement characteristics around the front of the user's head.

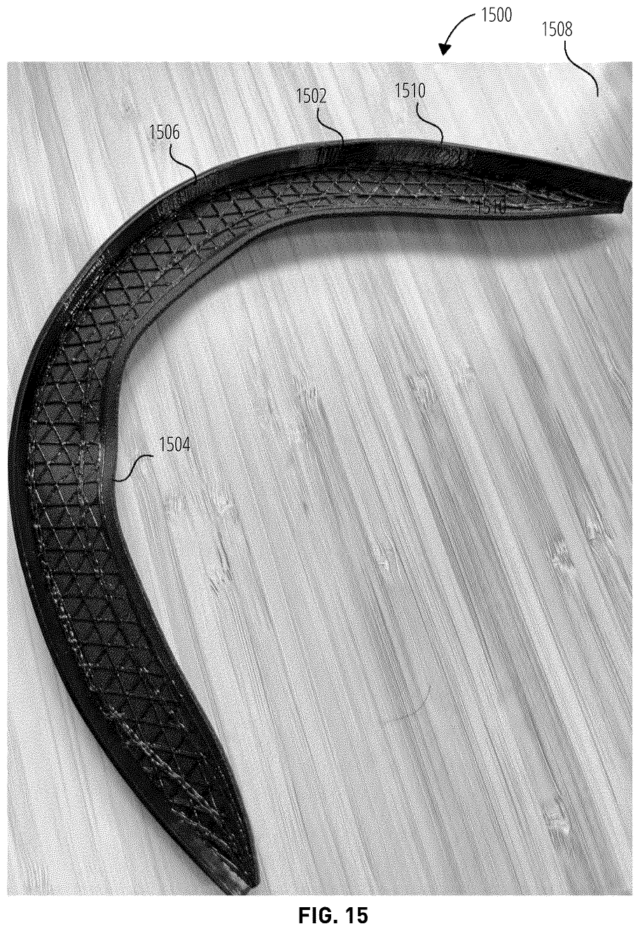

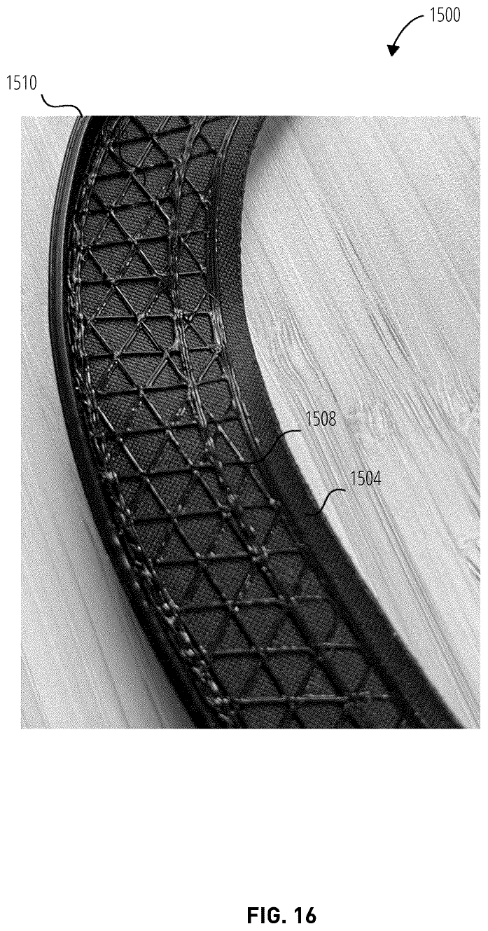

FIG. 15 and FIG. 16 show a pad assembly comprising a conformal band 1500 according to some further examples, with FIG. 16 being a closeup of a section of the conformal band 1500. The conformal band 1500 includes an absorbed foam strip 1504 and a support structure 1502 including a flange 1506 and an interlocking features 1510. The conformal band 1500 is generally crescent-shaped, with an inner profile of the foam strip 1504 intended to contact a user's forehead, and with the flange 1506 and interlocking feature 1510 curved to be received by a corresponding groove in a helmet as discussed above. In other examples, versions of the conformal band 1500 are provided that run longitudinally along the inside of the helmet, or at the back of the helmet.

As can be seen in FIG. 16, the support structure 1502 adjacent to the foam strips 1504 are formed as an open mesh 1508 of FDM filaments laid down on top of the foam strip 1504. Receipt of sweat by the foam strip is facilitated by the use of the open mesh 1508.

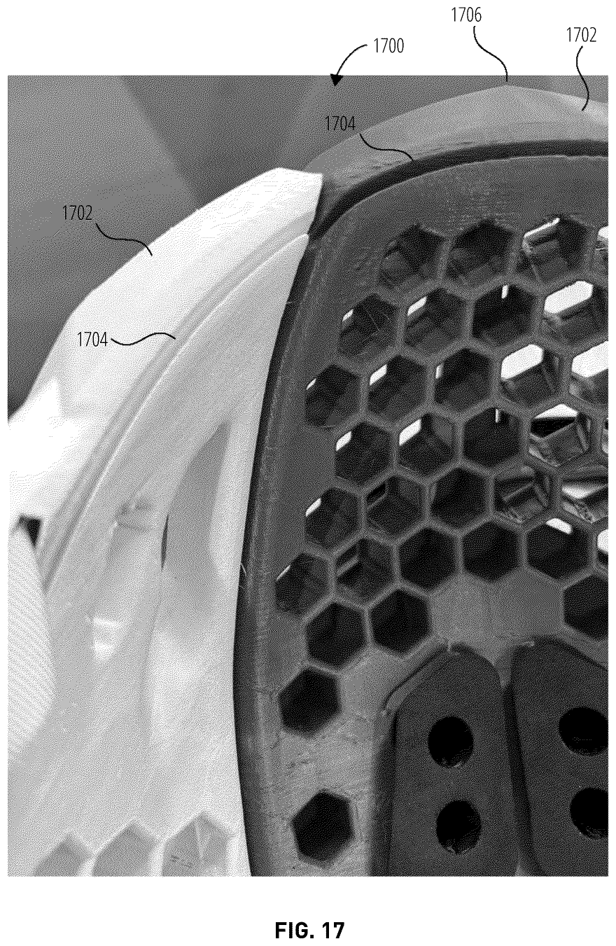

FIG. 17 is perspective view of the interior of a helmet 1700 according to some examples. The helmet 1700 includes a substrate or shell 1702 formed of a number of additively manufactured pieces, having a groove 1704 defined therein for receiving a conformal band 900, 1300 or 1500. The groove 1704 is positioned along an inner lower periphery of the helmet 1700, towards which sweat collected by a pad 902, 1304 or 1504 will run in use. In the case of a cycling helmet, which is often tipped forward in use, the sweat will gather and run towards a front edge 1706, which is slightly pointed as shown, to permit sweat reaching the front edge to drip off the helmet. The front edge 1706 and its point is sufficiently far from the user's forehead that any sweat dripping off the front edge will miss the user's nose even when the user's head is upright.

Various examples are contemplated. Example 1 is a pad assembly for a helmet, comprising: a pad formed of a first material; and a support structure of a second material that is formed on and bonded to the pad by means of an additive manufacturing process, the first material and the second material being selected to bond together when the support structure is formed on the pad during the additive manufacturing process.

In Example 2, the subject matter of Example 1 includes, wherein the pad comprises an absorbent strip and the support structure comprises a flange along an edge of the absorbent strip, the flange being shaped and sized to be received in a corresponding groove in a helmet.

In Example 3, the subject matter of Example 2 includes, wherein the flange is at an obtuse angle to the absorbent strip.

In Example 4, the subject matter of Examples 2-3 includes, wherein the support structure comprises an interlocking feature located along a top edge of the flange.

In Example 5, the subject matter of Examples 2-4 includes, wherein the support structure adjacent to the pad comprises an open mesh of Fused Deposition Modeling filaments.

In Example 6, the subject matter of Examples 1-5 includes, wherein the support structure comprises a plate having posts formed thereon for engaging corresponding holes formed in a helmet.

In Example 7, the subject matter of Example 6 includes, wherein the plate is formed and bonded on the pad using additive manufacturing and wherein the posts are formed on an opposite side of the pad using additive manufacturing.

Example 8 is a helmet, comprising: a shell and a pad assembly attached thereto, the helmet having a recess formed therein for receiving the pad assembly, the pad assembly comprising: a pad formed of a first material; and a support structure of a second material that is formed on and bonded to the pad by means of an additive manufacturing process, the first material and the second material being selected to bond together when the support structure is formed on the pad during the additive manufacturing process.

In Example 9, the subject matter of Example 8 includes, wherein the pad comprises an absorbent strip and the support structure comprises a flange along an edge of the absorbent strip, the flange being shaped and sized to be received in a corresponding groove in a helmet.

In Example 10, the subject matter of Example 9 includes, wherein the flange is at an obtuse angle to the absorbent strip.

In Example 11, the subject matter of Examples 9-10 includes, wherein the support structure comprises an interlocking feature located along a top edge of the flange.

In Example 12, the subject matter of Examples 8-11 includes, wherein the support structure comprises a plate having posts formed thereon for engaging corresponding holes formed in a helmet.

In Example 13, the subject matter of Example 12 includes, wherein the plate is formed and bonded on the pad using additive manufacturing and wherein the posts are formed on an opposite side of the pad using additive manufacturing.

Example 14 is a method of manufacturing a pad assembly for a helmet, comprising: providing a pad formed of a first material; and additively manufacturing a support structure of a second material on the pad, the first material and the second material being selected to bond together when the support structure is formed on the pad during the additive manufacturing.

In Example 15, the subject matter of Example 14 includes, wherein providing the pad comprises cutting the pad into a desired shape, and locating the pad in a jig on a print bed.

In Example 16, the subject matter of Examples 14-15 includes, additively manufacturing the jig on the print bed.

In Example 17, the subject matter of Examples 14-16 includes, wherein the pad comprises an absorbent strip and the support structure comprises a flange along an edge of the absorbent strip, the flange being shaped and sized to be received in a corresponding groove in a helmet.

In Example 18, the subject matter of Example 17 includes, wherein the support structure comprises an interlocking feature located along a top edge of the flange.

In Example 19, the subject matter of Examples 14-18 includes, wherein the support structure comprises a plate having posts formed thereon for engaging corresponding holes formed in a helmet.

In Example 20, the subject matter of Examples 14-19 includes, wherein the support structure adjacent to the pad comprises an open mesh of Fused Deposition Modeling filaments.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20. Example 23 is a system to implement of any of Examples 1-20. Example 24 is a method to implement of any of Examples 1-20.

1. A pad assembly for a helmet, comprising:
a pad formed of a first material; and
a support structure of a second material that is formed on and bonded to the pad by means of an additive manufacturing process, the first material and the second material being selected to bond together when the support structure is formed on the pad during the additive manufacturing process.

2. The pad assembly of claim 1, wherein the pad comprises an absorbent strip and the support structure comprises a flange along an edge of the absorbent strip, the flange being shaped and sized to be received in a corresponding groove in a helmet.

3. The pad assembly of claim 2, wherein the flange is at an obtuse angle to the absorbent strip.

4. The pad assembly of claim 2, wherein the support structure comprises an interlocking feature located along a top edge of the flange.

5. The pad assembly of claim 2, wherein the support structure adjacent to the pad comprises an open mesh of Fused Deposition Modeling filaments.

6. The pad assembly of claim 1, wherein the support structure comprises a plate having posts formed thereon for engaging corresponding holes formed in a helmet.

7. The pad assembly of claim 6, wherein the plate is formed and bonded on the pad using additive manufacturing and wherein the posts are formed on an opposite side of the pad using additive manufacturing.

8. A helmet, comprising:
a shell and a pad assembly attached thereto, the helmet having a recess formed therein for receiving the pad assembly, the pad assembly comprising:
a pad formed of a first material; and
a support structure of a second material that is formed on and bonded to the pad by means of an additive manufacturing process, the first material and the second material being selected to bond together when the support structure is formed on the pad during the additive manufacturing process.

9. The helmet of claim 8, wherein the pad comprises an absorbent strip and the support structure comprises a flange along an edge of the absorbent strip, the flange being shaped and sized to be received in a corresponding groove in a helmet.

10. The helmet of claim 9, wherein the flange is at an obtuse angle to the absorbent strip.

11. The helmet of claim 9, wherein the support structure comprises an interlocking feature located along a top edge of the flange.

12. The helmet of claim 8, wherein the support structure comprises a plate having posts formed thereon for engaging corresponding holes formed in a helmet.

13. The helmet of claim 12, wherein the plate is formed and bonded on the pad using additive manufacturing and wherein the posts are formed on an opposite side of the pad using additive manufacturing.

14. A method of manufacturing a pad assembly for a helmet, comprising:
providing a pad formed of a first material; and
additively manufacturing a support structure of a second material on the pad, the first material and the second material being selected to bond together when the support structure is formed on the pad during the additive manufacturing.

15. The method of claim 14, wherein providing the pad comprises cutting the pad into a desired shape, and locating the pad in a jig on a print bed.

16. The method of claim 14, further comprising:
additively manufacturing the jig on the print bed.

17. The method of claim 14, wherein the pad comprises an absorbent strip and the support structure comprises a flange along an edge of the absorbent strip, the flange being shaped and sized to be received in a corresponding groove in a helmet.

18. The method of claim 17, wherein the support structure comprises an interlocking feature located along a top edge of the flange.

19. The method of claim 14, wherein the support structure comprises a plate having posts formed thereon for engaging corresponding holes formed in a helmet.

20. The method of claim 14, wherein the support structure adjacent to the pad comprises an open mesh of Fused Deposition Modeling filaments.
